(19) United States
(12) Patent Application Publication
(10) Pub. No.: US 2024/0150576 A1
(43) Pub. Date: May 9, 2024

(54) A POLYAMIDE OR FLUOROPOLYMER COMPOSITE MATERIAL AND METHOD OF ITS PREPARATION

(71) Applicant: KLJ POLYMERS AND CHEMICALS LIMITED, Silvassa (IN)

(72) Inventors: Pravin BORADE, Silvassa, OT (IN); RAHUL GUPTA, Silvassa, OT (IN); MM BISWAL, Silvassa, OT (IN)

(73) Assignee: KLJ POLYMERS AND CHEMICALS LIMITED, Silvassa (IN)

(21) Appl. No.: 18/550,466

(22) PCT Filed: Mar. 13, 2022
(86) PCT No.: PCT/IB2022/052235

§ 371 Date: Sep. 14, 2023

(30) Foreign Application Priority Data
Mar. 14, 2021 (IN) 202121010696

(51) Int. Cl. C08L 77/00; B29C 48/00; B29C 48/40; B29K 77/00; C08K 3/013; C08K 3/30; C08K 5/20; C08K 5/52; C08K 7/14

(52) U.S. Cl. CPC C08L 77/00; B29C 48/022; B29C 48/40; C08K 3/013; C08K 3/30; C08K 5/20; C08K 5/52; C08K 7/14; B29C 2948/92704; B29K 2077/00; C08K 2003/3009; C08K 2201/012; C08L 2205/16

(57) ABSTRACT

The present invention provides a composite material comprising of a polyamide material including PA66, and/or a fluoropolymer material including polytetrafluoroethylene (PTFE), glass fibers, additives and pigments and method of its preparation by compounding extrusion or injection moulding processes. The composite material sustains the high heat generated due to spark in the electrical circuit, has lowest coefficient of friction (COF) so that the socket shutter provides smooth operation of inserting and removing the plug, has very low cycle time in injection moulding process ensuring high productivity and provides custom made colours required for aesthetic purpose.

### FIELD OF THE INVENTION

The present invention relates to a composite material and method of its preparation. More particularly, the present invention relates to a composite material comprising of a polyamide material and/or a fluoropolymer material and method of its preparation by compounding extrusion or injection moulding processes.

### BACKGROUND OF THE INVENTION

Polyamide (PA) is polymer having repeating units linked by amide groups (—CO—NH—) in a macromolecular main chain. PAs are prepared by polycondensation of diamine and diacid, or ring opening polymerization of lactam. PAs have several characteristics is including low coefficient of friction (COF), flame retardance, heat, chemical as well as abrasion resistance. Moreover, PAs are lubricative in nature. Besides, PAs also show compatibility for mixing with glass fibers, and other fillers that improve overall performance of the composite material thereby expanding the scope of their application in manufacturing mechanical, chemical or electrical parts.

Polytetrafluoroethylene (PTFE) is a synthetic fluoropolymer produced by free-radical polymerization of tetrafluoroethylene. PTFE is a thermoplastic polymer having high strength, toughness, self-lubrication at low temperatures, is hydrophobic and has the lowest COF that exists for any solid.

CN109957240 relates to a thermoplastic halogen-free low phosphorus flame-retardant reinforced bio-based polyamide 56 (PA 56) and polyamide 66 (PA66) composite material and a preparation method thereof. The PA56 and PA66 composite material is at least prepared from the following raw materials in percentage by mass: 15-65% of bio-based PA56, 15-65% of PA66, 15-40% of alkali-free glass fibers, 5-7% of a melamine cyanurate (MCA) flame retardant and 1-10% of a phosphorus flame retardant synergist.

CN105694445 The invention discloses a preparation method of a wear resisting PA66 composite material. The preparation method includes the steps of 1) uniformly mixing, by mass, 60-90 parts of PA66, 10-30 parts of glass fiber, 2-5 parts of molybdenum trisulfide powder capsules, 0.1-0.3 part of antioxidant and 1-3 parts of compatilizer; 2) subjecting uniformly mixed raw materials to melt extrusion and pelleting so as to obtain the wear-resisting PA66 composite material. By the preparation method of the wear-resisting PA66 composite material, the problem of low single abrasion resistance of a single material is solved.

CN109294227 relates to polyamide material for replacing the metal material comprising of polyamide, glass fibers, glass microbeads, a toughening agent, an anti-wear agent, a weather-resistant additive and other additives.

CN104231611A relates to a method for preparing glass fiber reinforced nylon, which requires professional modification of equipment, has great difficulty in specific implementation and is not easy to realize industrial batch production.

CN104231613A relates to a glass fiber and glass bead composite modified polyamide material, which improves the dimensional stability and warp resistance of the product.

U.S. Pat. No. 6,262,209 relates to a process for producing polytetrafluoroethylene (PTFE) modified by a suspension process, but use of PTFE as lubricant is not disclosed.

Study on the Friction and Wear Behaviors of Modified PA66 Composites. Xing, Y., Zhang, G., Ma, K., Chen, T., & Zhao, X. (2009). Polymer-Plastics Technology and Engineering, 48(6), 633-638. doi:10.1080/03602550902824481 discloses about the study of wear resistance and friction behaviour of PA66 composites. It talks about improving the mechanical, friction and wear properties of PA66 composites by addition of GF, (polytetrafluoroethylene) PTFE and MoS₂.

However, inventions heretofore known suffer from a number of disadvantages. Material/compositions disclosed in the prior art doesn't sustain the high heat resulting in premature failure of the composite thus generated. PTFE offers lowest COF however it is not used directly in extrusion/injection moulding operations by any of the prior arts. This is due to very high bond energy thus resulting in high melting temperature resulting in its non-processing via extrusion/injection moulding route. Molybdenum disulphide and graphite also offers lowest COF. However, compounds made from molybdenum disulphide and graphite are not only black in colour but they also do not provide custom made colours required for aesthetic purpose.

Accordingly, there is a need for an approach that resolves the problems of the state of art to provide a composite material that sustains high heat, has low COF and is made available in custom colours. The present invention is an endeavour in this direction. The present invention provides a composite material comprising of a polyamide material including PA66 and/or a fluoropolymer material including polytetrafluoroethylene (PTFE) and a method of its preparation by compounding extrusion or injection moulding processes. The composite material thus generated ought to have low cycle time in injection moulding process ensuring high productivity. Besides this, PTFE must be used directly during extrusion operations.

### OBJECT OF THE INVENTION

The main object of the present invention is to provide a composite material comprising is of a polyamide material and a fluoropolymer material.

Another object of the present invention is to provide a composite material that has high glow wire ignition temperature, low coefficient of friction (COF) as well as sustains the high heat generated due to spark in the electrical circuit.

Yet another object of the present invention is to provide a composite material that is employed especially in areas that involves moving parts for several industries including chemical industry wherein low COF, better chemical resistance and high stiffness is required.

Still another object of the present invention is to provide a method for preparation of a composite material by compounding extrusion or injection moulding processes.

Yet another object of the present invention is to provide a method for preparation of a composite material that has low cycle time in injection moulding process and provides custom made colours.

### SUMMARY OF THE INVENTION

In an embodiment, the present invention provides a composite material comprising of a desired amount of composite material comprising of desired amount of a polyamide and/or a fluoropolymer, glass fibers, an antioxidant, an additive and a pigment.

The polyamide material is selected from a group containing PA66, Nylon 66, Poly(hexamethylene adipamide),Poly(N,N′-hexamethyleneadipinediamide), Maranyl, Ultramid, Zytel, Akromid, Durethan, Frianyl, Vydyne. The fluoropolymer material is selected form a group containing polytetrafluoroethylene (PTFE), Inolub, Teflon, Fluon, Hostaflon, and Polyflon. Antioxidants, additives and pigments present in the composition are selected from a group containing phenolic antioxidant including Irganox 1098, phosphite antioxidant including Irgafos 168, lubricant is fatty bisamide wax (Finawax C) and zinc sulphide (Sachtolith HDS) as white pigment. The composite material thus formed sustains high heat absorption capacity and has high glow wire ignition temperature and tensile strength. The composite material has low coefficient of friction.

In another preferred embodiment, the present invention provides a method for preparation of composite material comprising of a polyamide material and/or a fluoropolymer material by compounding extrusion.

In another preferred embodiment, the present invention provides a method for preparation of composite material comprising of a polyamide material and/or a fluoropolymer material by injection moulding processes.

### BRIEF DESCRIPTION OF THE DRAWINGS

The object of the invention may be understood in more details and more particularly description of the invention briefly summarized above by reference to certain embodiments thereof which are illustrated in the appended drawings, which drawings form a part of this specification. It is to be noted, that the appended drawings illustrate preferred embodiments of the invention and are therefore not to be considered limiting of its scope, for the invention may admit to other equally effective equivalent embodiments.

FIG. 1 elucidates a thermal gravimetric analysis (TGA) curve of the composite material of the present invention.

FIG. 2 elucidates a differential scanning calorimetry (DSC) curve of the composite material of the present invention.

### DETAILED DESCRIPTION OF THE INVENTION

The present invention will now be described more fully hereinafter. This invention may, however, be embodied in many different forms and should not be construed as being limited to the embodiment set forth herein. Rather, the embodiment is provided so that this disclosure will be thorough, and will fully convey the scope of the invention to those skilled in the art.

Engineering plastics are a group of plastics that are mostly used in industries due to their enhanced thermal and mechanical properties when compared to widely used commodity plastics such as PVC, polystyrene, polypropylene and polyethylene. Engineering plastics generally refer to the thermoplastic materials rather than thermosetting ones. The most common examples of engineering plastics include polyamides (PA, nylons), is polycarbonates (PC), and poly (methyl methacrylate) (PMMA). Presently, the most-consumed engineering plastic is acrylonitrile butadiene styrene (ABS) which is very well used in car bumpers, dashboard trim and Lego bricks.

Polyamide (PA), is a wear-resistant engineering plastic having has high strength, superior wear resistance and self-lubricating characteristic. This is due to the presence of van der Waals force and hydrogen bonds in molecular chains of the polyamide. Therefore, polyamide is eligible for many engineering parts undergoing friction and wear, namely bearing and gear. Pure polymers materials are less suitable for this purpose due to their lower mechanical strength and low heat absorbing capacity. The solution to these problems is the production of compounds that are reinforced with different materials and additives resulting in enhancement of its mechanical properties and tribological property by adding fiber and solid lubricants resulting in composites of high theoretical significance and value. The most common reinforcements and lubricants used for anti-abrasion applications include polytetrafluoroethylene (PTFE), silicone, glass fiber, carbon fiber, and aramid fiber.

In a preferred embodiment, the present invention provides a composite material, comprising of a desired amount of 40-80% w/w of a polyamide, 0-20% w/w, of a fluoropolymer, 0-35% w/w of a glass fiber, 0.35% w/w, of an antioxidant, 0.3% w/w of an additive lubricant and 0-1.0% w/w of a pigment, that sustains high heat absorption capacity. The polyamide material is selected from a group containing PA66, Nylon 66, poly(hexamethylene adipamide), poly(N,N′-hexamethyleneadipinediamide), Maranyl, Ultramid, Zytel, Akromid, Durethan, Frianyl, Vydyne. The fluoropolymer material is selected form a group containing polytetrafluoroethylene (PTFE), Inolub, Teflon, Fluon, Hostaflon, and Polyflon. The antioxidants, additives and pigments are selected from phenolic antioxidant including Irganox 1098, phosphite antioxidant including Irgafos 168, lubricant including fatty bisamide wax (Finawax C) and zinc sulphide (Sachtolith HDS) as white pigment respectively.

The present invention provides a composite material that has high glow wire ignition temperature in a range of 472° C.-574° C., sustains high heat in a range of 750° C. generated due to spark in an electrical circuit, has a minimum tensile strength of 1700 kgf/cm² and has low coefficient of friction (COF) in a range of 0.02-0.35. These properties make the composite material according to the present invention suitable for socket shutter by providing smooth operation for inserting and removing the plug. The composite material according to the present invention has low cycle time in a range of 20-25 seconds in injection moulding process, thus ensuring high productivity and the composition material according to the instant invention is made in custom colours for aesthetic purpose.

Therefore, the present invention provides a composite material employed especially in areas involving moving parts for several industries including chemical industry wherein lowest COF, better chemical resistance and high stiffness is required. The composite material of the present invention has low COF that sustain high heat demanded by the application to avoid premature failure, low cycle time in injection moulding process ensuring high productivity and PTFE of composite material is used directly during injection moulding operations. An article developed from the composite material of the present invention is used as rocker and plunger, and shutter in electrical applications like switches and sockets. Dynamic COF has been determined by Instron 3365 UTM using ASTM D 1894.

In another embodiment, the present invention provides a method for preparation of composite material comprising of a polyamide material and a fluoropolymer material by compounding extrusion and injection moulding processes. The method for preparation of composite material by compounding extrusion comprising feeding 40 to 80% w/w polyamide and 0 to 20% w/w fluoropolymer, 0 to 2% w/w additives, 0.15% w/w antioxidant and 0 to 5% w/w pigments from throat or main feed feeding and 0 to 35% w/w glass fibres from side feeder 1 or 2 in twin or single screw extruder, more preferably from twin-screw extruder to obtain homogeneous composite material.

The polyamide is selected from a group containing PA66, Nylon 66, Poly(hexamethylene adipamide),Poly(N,N′-hexamethyleneadipinediamide), Maranyl, Ultramid, Zytel, Akromid, Durethan, Frianyl, Vydyne. The fluoropolymer is selected from a group containing polytetrafluoroethylene, Inolub, Teflon, Fluon, Hostaflon, and Polyflon. The antioxidants are selected from a group consisting of Irganox 1098 and Irgafos 168. The additive and the pigment is fatty bisamide wax and zinc sulphide respectively. The glass fibres are fed downstream to maintain the integrity of the glass fibre structures to achieve maximum mechanical properties with a minimum tensile is strength of 1700 kgf/cm².

In a preferred embodiment of the present invention is provided the method of optionally feeding the PTFE through side feeder and the glass fiber through main feed to cover the entire range of process ability of adding polymers, filler, and additives through various possible port of addition in an extruder.

Polymeric granules are used in the injection moulding process which are formed from a composite material produced on twin screw extruder.

In still another preferred embodiment, the present invention provides a method for preparation of composite material by injection moulding process comprising the steps of:
a) drying polymeric granules and placing in a hopper,
b) feeding dried polymeric granules obtained in step a. into a barrel and simultaneously heating, mixing to obtain a homogenous composite material.
c) moving the composite material obtained in step b. towards a mould by a variable pitch screw and moulding it at a temperature in a range of 250 to 290° C. and shear rate involved in extrusion process in a range of 1000 to 1500 sec⁻¹;
d) optimizing geometry of the barrel and the variable pitch screw of step c. to build up pressure and melting said dried polymeric granules to a melted plastic;
e) moving the variable pitch screw forward and injecting the melted plastic obtained in step d. into the mould and filling whole cavity through a runner system to obtain molten plastic;
f) cooling down the molten plastic obtained in step e. to re-solidify and take shape of a mould;
g) opening the mould obtained in step f. and pushing out the solid part by ejector pins; and
h) closing the mould and the step a) to f) is repeated as per requirements to provide an article of desired composite material;

The polyamide is selected from a group containing PA66, Nylon 66, Poly(hexamethyleneadipamide), Poly(N,N′-hexamethyleneadipinediamide), Maranyl, is Ultramid, Zytel, Akromid, Durethan, Frianyl, Vydyne. The fluoropolymer is selected from a group containing polytetrafluoroethylene (PTFE), Inolub, Teflon, Fluon, Hostaflon, and Polyflon; The antioxidants are selected from a group consisting of Irganox 1098 and Irgafos 168. The additive and the pigment is fatty bisamide wax and zinc sulphide respectively. Polytetrafluoroethylene (PTFE) is used directly during injection moulding/extrusion operations; The mould is selected from a group consisting of plunger, retainer, and shutter mould. The material has low cycle time of 20-25 seconds in injection moulding process ensuring high productivity. The composite material is made in different colours.

Therefore, the present invention provides a composite material employed especially in areas involving moving parts for several industries including chemical industry wherein lowest COF, better chemical resistance and high stiffness is required. The composite material is having low COF that sustain high heat demanded by the application to avoid premature failure, low cycle time in injection moulding process ensuring high productivity and PTFE of composite material is used directly during injection moulding operations. An article developed from the composite material of the present invention is used as rocker and plunger, and shutter in electrical applications like switches and sockets.

### Example 1

### Preparation of Composite Material

The composite is prepared on twin screw extruder with screw diameter of 35 mm and Length to Diamter ratio of 48. The polyamide material including PA66 and/or a fluoropolymer material including polytetrafluoroethylene (PTFE), additives and pigments from throat or main feed and glass fibers from side feeder 2. The following process parameters were used:

Screw RPM: 450 to 550

Output: 80 to 100 kgs/hr

Temperature Profile:

TABLE 1
Temperature profile of preparation of composite material

| Zone | Spec |
|---|---|
| Zone T1 | 260 |
| Zone T2 | 285 |
| Zone T3 | 285 |
| Zone T4 | 285 |
| Zone T5 | 285 |
| Zone T6 | 280 |
| Zone T7 | 280 |
| Zone T8 | 280 |
| Zone T9 | 275 |
| Zone T10 | 275 |
| Zone T11 | 275 |
| Die Head | 280 |

The composite material is molded on 80T in an injection molding machine with temperature profile of 265 to 285° C. The composite material is preheated at 80 to 85° C. before doing injection molding.

### Example 2

### Differential Scanning Calorimetry (DSC) Analysis of the Composite Material

DSC enables the measurements of the transition such as the glass transition, melting, and crystallization. The chemical reaction such as thermal curing, heat history, specific heat capacity, and purity analysis are also measurable. DSC can perform the quantitative measurement of the amount of heat on top.

Scope:

To determines the This test method is applicable to polymers in granular form (below 60 mesh preferred, avoiding grinding if possible) or to any fabricated shape from which appropriate specimens can be cut.

Test Procedure:

ASTM D 3418 & ISO 11357 part 1 to 7

This test method is useful for specification acceptance, process control, and research.

Temperature Range of the equipment used in the present invention: (−) 70° to 600° C.

A small amount of sample (1-15 mg) was contained within a closed crucible and placed into a temperature-controlled DSC cell.

A second crucible without sample is used as a reference.

A typical DSC run involves heating/cooling the sample at a controlled steady rate, and monitoring the heat flow to characterize the phase transitions and/or cure reactions as a function of temperature.

Modulated DSC which utilizes a temperature modulation technique can be used to determine weak transitions and separate overlapping thermal events.

The ASTM Heating Rate is 10° C./minute for melting point (Tm), 20° C. for glass transition (Tg). The ISO Heating Rate is 20° C./minute.

Specimen Size:

Since milligram quantities of a specimen are used, it is essential to ensure that specimens are homogeneous and representative.
1) Powdered or Granular Specimens—can be used but precaution should be taken that grinding does not affect its thermal properties.
2) Molded or Pelleted Specimens—Cut the specimens with a microtome, razor blade, hypodermic punch,
3) Film or Sheet Specimens—For films thicker than 40 μm, cut with razor blade

Data: Key elements of DSC analysis

Using a DSC (differential scanning calorimeter) the following are commonly determined: A thermal scan, depending upon the material type, can provide a Tg, Tm, ΔHm and or ΔHc.

Tg=Glass Transition Temperature=Temperature (° C.) at which an amorphous polymer or an amorphous part of a crystalline polymer goes from a hard brittle state to a soft rubbery state.

Tm=melting point=Temperature (° C.) at which a crystalline polymer melts.

ΔHm=the amount of energy (joules/gram) which a sample absorbs while melting.

Tc=crystallization point=Temperature at which a polymer crystallizes upon heating or cooling.

ΔHc=the amount of energy (joules/gram) a sample releases while crystallizing.

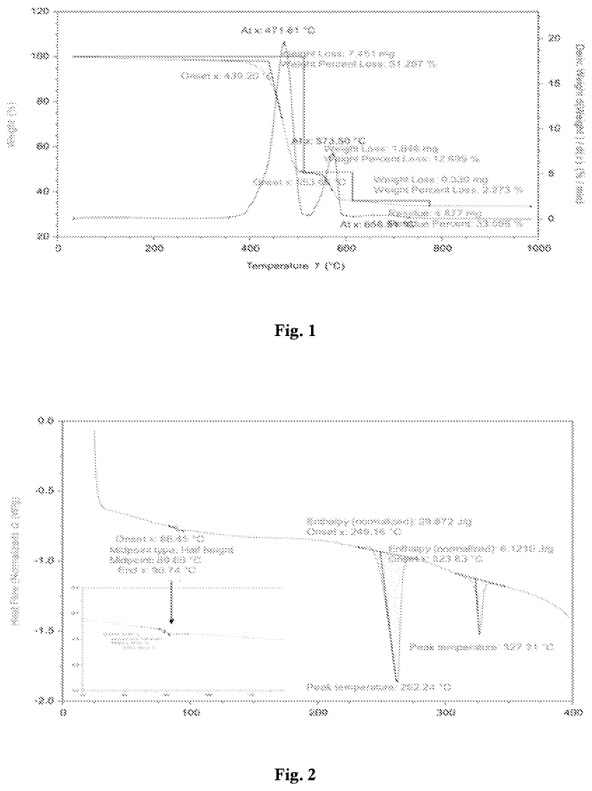

The DSC composite material wherein a DSC analysis is done on TA Instruments DSC model using sample size of 5 mg±1 and a ramp rate of 20° C./min. The melting point of 262.2 corresponds to typical PA66 melting transition and another melting point is observed at 327.2° C., 1 mg corresponds to typical PTFE transition as depicted in FIG. 1.

### Example 3

### Thermogravimetry Thermal Analysis (TGA) ASTM E1131, ISO 11358TGA of the Composite Material

Thermogravimetric (TGA) analysis provides determination of endotherms, exotherms, weight loss on heating, cooling, and more. Materials analyzed by TGA include polymers, plastics, composites, laminates, adhesives, food, coatings, pharmaceuticals, organic materials, rubber, petroleum, chemicals, explosives and biological samples.

Scope:

Thermogravimetric analysis measures the percent weight loss of a test sample while the sample is heated at a uniform rate in an appropriate environment. The loss in weight over specific temperature ranges provides an indication of the composition of the sample, including volatiles and inert filler, as well as indications of thermal stability

Test Equipment:

Temperature Range: Ambient to 1000° C.

Sample weight Capacity: 1000 mg

Heating Rate: 0.1 to 100° C.

Test Procedure:

Set the inert (usually N₂) and oxidative (O₂) gas flow rates to provide the appropriate environments for the test. Place the test material in the specimen holder and raise the furnace. Set the initial weight reading to 100%, and then initiate the heating program.

The gas environment is preselected for either a thermal decomposition (inert—nitrogen gas), an oxidative decomposition (air or oxygen), or a thermal-oxidative combination.

Specimen Size:

10 to 15 milligrams

Data:

A plot of percent weight loss versus temperature.

Selected Applications in Industry:
Characterization of the thermal properties of materials such as plastics, elastomers and thermoset, mineral compounds, and ceramics, as well as for chemical products
Measurement of composition (e.g., organics, carbon black, filler), purity, decomposition reactions, decomposition temperatures, and absorbed moisture content.

A TGA analysis is done on TA Instruments TGA 55 model using sample size of 15 mg±1 and a ramp rate of 20° C./min. The weight loss of around 51.3% at 472° C. corresponds to PA66 decomposition, second decomposition at 574° C. of 12.7% corresponds to PTFE decomposition and the final residue of 33.5% corresponds to inorganic glass filler as depicted in FIG. 2.

### Example 4

### Glow Wire Flammability Index—IEC 60695-2-12

The glow wire test is used to simulate the effect of heat as may arise in malfunctioning electrical equipment, such as with overloaded or glowing components. Test results provide a way of comparing the ability of materials to extinguish flames and their ability to not produce particles capable of spreading fire.

The glow wire is heated via electrical resistance to 750° C. A test specimen is held for 30 seconds against the tip of the glow wire with a force of 1 N. After the glow wire is removed, the time for the flames to extinguish is noted along with details of any burning drops. Cotton is placed beneath the specimen during the test to determine the effects of burning drops.

The Glow Wire Flammability Index is the highest temperature which satisfies one of the following conditions in three successive tests:
1. There is no flame and no glowing (no ignition).
2. Burning or glowing time is less than 30 seconds after removal of the glow wire and the cotton does not ignite.

Table 2 summarizes the test result of glow wire test with different concentration of the chemicals used in the composite.

TABLE 2
Shows different properties of the composition of the present
invention with varying percentages of its components

| CHEMICALS | % | % | % |
|---|---|---|---|
| POLYMER | | | |
| PA66 | 52.700 | 65.7 | 79.4 |
| INOLUB T110 (PTFE) | 13.000 | 0 | 20 |
| E-GLASS CHOPPED STRAND | 33.000 | 33 | 0 |
| ECS 03T-275H/P | | | |
| IRGAFOS 1098 | 0.150 | 0.15 | 0.15 |
| Irgafos 168 | 0.150 | 0.15 | 0.15 |
| PINAWAX-C | 0.300 | 0.3 | 0.3 |
| HDS | 0.700 | 0.7 | 0 |
| TOTAL QUANTITY (KG) | 100.000 | 100.000 | 100.000 |

| | | Test | | | |
|---|---|---|---|---|---|
| PROPERTIES | UNIT | Method | RESULT | RESULT | RESULT |
| SPECIFIC GRAVITY | — | ASTM D792 | 1.5 | 1.39 | 1.25 |
| MELT FLOW INDEX @ | GM/10 MIN | ASTM D1238 | 7.2 | 5 | NA |
| 275/2.16 KG, 300 SEC | | | | | |
| PREHEAT | | | | | |
| TENSILE STRESS AT | KGF/CM² | ASTM D638 | 1,800 | 1950 | 700 |
| BREAK | | | | | |
| ELONGATION AT | % | ASTM D638 | 3 | 3 | 12 |
| BREAK | | | | | |
| IZOD IMPACT | KGFCM/CM | ASTM D256 | 13.5 | 13 | 5 |
| STRENGTH | | | | | |
| GWT @750° C. | | IEC 60695- | Pass | Pass | Pass |
| | | 2-13 | | | |
| Static COF | | ASTM D1894 | 0.12 | 0.35 | 0.09 |
| Dynamic COF | | ASTM D1894 | 0.04 | 0.31 | 0.02 |

### Example 5

### Izod Impact (Notched) ASTM D256, ISO 180

Izod Impact Testing (Notched Izod) is a common test to understand notch sensitivity in plastics.

Scope:

Notched Izod Impact is a single point test that measures a materials resistance to impact from a swinging pendulum. Izod impact is defined as the kinetic energy needed to initiate fracture and continue the fracture until the specimen is broken. Izod specimens are notched to prevent deformation of the specimen upon impact. This test can be used as a quick and easy quality control check to determine if a material meets specific impact properties or to compare materials for general toughness.

Test Procedure:

The specimen is clamped into the pendulum impact test fixture with the notched side is facing the striking edge of the pendulum. The pendulum is released and allowed to strike through the specimen. If breakage does not occur, a heavier hammer is used until failure occurs. Since many materials (especially thermoplastics) exhibit lower impact strength at reduced temperatures, it is sometimes appropriate to test materials at temperatures that simulate the intended end use environment.

Reduced Temperature Test Procedure:

The specimens are conditioned at the specified temperature in a freezer until they reach equilibrium. The specimens are quickly removed, one at a time, from the freezer and impacted. Neither ASTM nor ISO specify a conditioning time or elapsed time from freezer to impact—typical values from other specifications are 6 hours of conditioning and 5 seconds from freezer to impact.

Specimen Size:

The standard specimen for ASTM is 64×12.7×3.2 mm. The most common specimen thickness is 3.2 mm, but the preferred thickness is 6.4 mm (0.25 inch) because it is not as likely to bend or crush. The depth under the notch of the specimen is 10.2 mm.

The standard specimen for ISO is a Type 1A multipurpose specimen with the end tabs cut off. The resulting test sample measures 80×10×4 mm. The depth under the notch of the specimen is 8 mm.

Data:

ASTM impact energy is expressed in J/m or ft-lb/in. Impact strength is calculated by dividing impact energy in J (or ft-lb) by the thickness of the specimen. The test result is typically the average of 5 specimens.

ISO impact strength is expressed in kJ/m2. Impact strength is calculated by dividing impact energy in J by the area under the notch. The test result is typically the average of 10 specimens. The higher the resulting numbers the tougher the material.

Table 2 summarizes the test result of izod impact strength test with different is concentration of the chemicals used in the composite.

### Example 6

### Melt Flow Index, Melt Flow Rate, ASTM D1238, ISO 1133

Scope:

Melt Flow Rate measures the rate of extrusion of thermoplastics through an orifice at a prescribed temperature and load. It provides a means of measuring flow of a melted material which can be used to differentiate grades as with polyethylene, or determine the extent of degradation of the plastic as a result of molding. Degraded materials would generally flow more as a result of reduced molecular weight, and could exhibit reduced physical properties. Typically, flow rates for a part and the resin it is molded from are determined, and then a percentage difference is calculated. Alternatively, comparisons between “good” parts and “bad” parts may be of value.

Test Procedure:

Approximately 7 grams of the material is loaded into the barrel of the melt flow apparatus, which has been heated to a temperature specified for the material. A weight specified for the material is applied to a plunger and the molten material is forced through the die. A timed extrudate is collected and weighed. Melt flow rate values are calculated in g/10 min.

Specimen Size:

At least 14 grams of material

Data:

Flow rate=(600/t×weight of extrudate)
t=time of extrudate in seconds
melt flow rate=g/10 min.

Table 2 summarizes the test result of melt flow rate with different concentration of the chemicals used in the composite.

### Example 7

### Specific Gravity—ASTM D792

| Method | Description | Calculation |
|---|---|---|
| A | Testing in water | (apparent mass in air)/(apparent |
| | | mass in water) |

Scope:

Density is the mass per unit volume of a material. Specific gravity is a measure of the ratio of mass of a given volume of material at 23° C. to the same volume of deionized water. Specific gravity and density are especially relevant because plastic is sold on a cost per pound basis and a lower density or specific gravity means more material per pound or varied part weight.

Test Procedure:

For Method A, the specimen is weighed in air then weighed when immersed in distilled water at 23° C. using a sinker and wire to hold the specimen completely submerged as required. Density and Specific Gravity are calculated.

Specimen Size:

Any convenient size.

Data:

Specific gravity=a/[(a+w)−b]
a=mass of specimen in air.
b=mass of specimen and sinker (if used) in water.
W=mass of totally immersed sinker if used and partially immersed wire.

Density, kg/m3=(specific gravity)×(997.6).

Table 2 puts in a nutshell the test result of specific gravity of the composite material with different concentration of the chemicals used in the preparation of the said composite.

### Example 8

### Static COF—ASTM D 1894

ASTM D1894 is a standardized test method used for determining static (μ_s) and kinetic (β_k) coefficients of friction of plastic.

Scope:

To determines the friction characteristics of the film sliding over itself or other substances. Several designs of apparatus are permitted.

This test method measures the initial and moving friction of one material being dragged across another, otherwise known as the static (initial) and kinetic (moving) coefficients of friction (COF).

Test Procedure:

ASTM D1894 determines the friction characteristics of the film sliding over itself or other substances. Several designs of apparatus are permitted.
Horizontal test plane, of polished plastic, wood or metal sheet approx. 150×300 mm, optionally heated A smooth piece of glass may cover upper surface of plane.
Sled of mass 200±2 g, horizontal area dimensions 63.5 mm×63.5 mm and approx. 6 mm thick.
A driving mechanism to produce a relative motion between the sled and the test table.
A force measurement system where the pulling direction shall be in straight alignment with the frictional plane.
Elastic link to the sled. Use the rigid link to control stick-slip, if apparent.

Specimen Size:

Cut the sample to be attached to the plane to 250 mm×130 mm, usually in its machine direction and transverse direction respectively, to test. Sliding in the specimen's machine is direction. Attach securely via gripping.

Data:

Calculations

Calculate the coefficient of friction from the formula: p=F/mg, where mg is the sled weight. Calculate the mean of the set of observations and the standard deviation.

Table 2 sums up the test result of static COF of the composite material with different concentrations of the chemicals used in the preparation of the said composite.

### Example 9

### Tensile

### Test

### ASTM D-638 Plastics Tensile Testing Data Generation Services Including Tensile Strength, Tensile Modulus and Elongation

Tensile tests measure the force required to break a plastic sample specimen and the extent to which the specimen stretches or elongates to that breaking point.

Procedure:

Normal Room Temperature Test:

Temperate atmosphere: 23±2° C., 50±10% R. H.

Specimens are placed in the grips of the universal tester at a specified grip separation and pulled until failure.

The specimen is mounted in the test equipment with the help of variety of grips.

Normally we use Wedge action grips for our rigid plastics samples.

For ASTM D 638 the test speed is determined by the material specification. An extensometer is used to determine elongation and tensile modulus.

Elevated or Reduced temperature test procedure:

A thermal chamber is installed on the universal test machine. The chamber is designed to allow the test mounts from the base and crosshead of the universal tester to pass through the top and bottom of the chamber. The size of the chamber places a limitation on the maximum elongation that can be reached, and extensometers are generally limited to no more than 200° C.

Specimen size: The most common specimen for ASTM D-638 is a Type I tensile bar.

Remarks:

Type V is used for special circumstances, such as testing in a thermostatic chamber. (In addition, other shapes are specified, such as tube and rod shapes.)

The following calculations can be made from tensile test results:
Tensile strength (at yield and at break)
Tensile modulus
Strain
Elongation and percent elongation at yield
Elongation and percent elongation at break

Table 2 sums up the test result of Tensile strength of the composite material with different concentrations of the chemicals used in the preparation of the said composite.

Many modifications and other embodiments of the invention set forth herein will readily occur to one skilled in the art to which the invention pertain having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

We claim:

1. A composite material comprising of:
a desired amount of a polyamide, a fluoropolymer, a glass fiber, an antioxidant, an additive, and a pigment;
wherein:
said composite material sustains heat absorption capacity in a range of 472° C.-574° C.;
said composite material has high glow wire ignition temperature of 750° C. and a minimum tensile strength of 1700 kgf/cm²; and
said composite material has low coefficient of friction in a range of 0.02-0.35.

2. The composite material as claimed in claim 1, wherein the desired amount of the polyamide, the fluoropolymer, the glass fibers, the antioxidant, additives and the pigments is 40-80% w/w, 0-20% w/w, 0-35% w/w, 0.15% w/w, 0-2% w/w, 0.3% w/w and 0-5% w/w respectively.

3. The composite material as claimed in claim 1, wherein the polyamide is selected from a group containing PA66, Nylon 66, Poly(hexamethylene adipamide), Poly(N,N′-hexamethyleneadipinediamide), Maranyl, Ultramid, Zytel, Akromid, Durethan, Frianyl, Vydyne.

4. The composite material as claimed in claim 1, wherein the fluoropolymer is selected from a group containing polytetrafluoroethylene, Inolub, Teflon, Fluon, Hostaflon, and Polyflon.

5. The composite material as claimed in claim 1, wherein the antioxidants are selected from a group consisting of Irganox 1098 and Irgafos 168.

6. The composite material as claimed in claim 1, wherein the additive and the pigment are fatty bisamide wax and zinc sulphide respectively.

7. A method of preparing a composite material comprising of a polyamide and/or a fluoropolymer, a glass fibre, an antioxidant, an additive, and a pigment by compounding extrusion comprising feeding 40 to 80% w/w of a polyamide and 0 to 20% w/w of a fluoropolymer, 0 to 2% w/w of an additive, 0.15% w/w of an antioxidant and 0 to 5% w/w of a pigment from throat or main feed feeding and 0 to 35% w/w glass fibres from side feeder 1 or 2 in twin or single screw extruder, more preferably from twin-screw extruder to obtain homogeneous composite material;
wherein:
the polyamide is selected from a group containing PA66, Nylon 66, Poly(hexamethylene adipamide),Poly(N,N′-hexamethyleneadipinediamide), Maranyl, Ultramid, Zytel, Akromid, Durethan, Frianyl, Vydyne;
the fluoropolymer is selected from a group containing polytetrafluoroethylene, Inolub, Teflon, Fluon, Hostaflon, and Polyflon;
the antioxidants are selected from a group consisting of Irganox 1098 and Irgafos is 168;
the additive and the pigment are fatty bisamide wax and zinc sulphide respectively; and
the glass fibres are fed downstream to maintain the integrity of the glass fibre structures to achieve a minimum tensile strength of 1700 kgf/cm².

8. The method as claimed in claim 7, wherein optionally feeding the polytetrafluoroethylene through side feeder and the glass fiber through main feed to cover the entire range of process ability of adding polymers, filler, and additives through various port of addition in an extruder.

9. A method of preparing a composite material comprising of dried polymeric granules of a polyamide and/or a fluoropolymer, a glass fibre, an antioxidant, an additive, and a pigment by injection moulding process comprising the steps of:
a) drying polymeric granules and placing in a hopper,
b) feeding dried polymeric granules obtained in step a. into a barrel and simultaneously heating, mixing to obtain homogeneous composite material;
c) moving the composite material obtained in step b. towards a mould by a variable pitch screw and moulding it at a temperature in a range of 250 to 290° C. and shear rate involved in extrusion process in a range of 1000 to 1500 sec⁻¹;
d) optimizing geometry of the barrel and the variable pitch screw of step c. to build up pressure and melting said dried polymeric granules to a melted plastic;
e) moving the variable pitch screw forward and injecting the melted plastic obtained in step d. into the mould and filling whole cavity through a runner system to obtain molten plastic;
f) cooling down the molten plastic obtained in step e. to re-solidify and take shape of a mould;
g) opening the mould obtained in step f. and pushing out the solid part by ejector pins; and
h) closing the mould and the step a) to f) is repeated as per requirements to provide an article of desired composite material;
wherein:
the polyamide is selected from a group containing PA66, Nylon 66, Poly(hexamethyleneadipamide),Poly(N,N′hexamethyleneadipinediamide), Maranyl, Ultramid, Zytel, Akromid, Durethan, Frianyl, Vydyne;
the fluoropolymer is selected from a group containing polytetrafluoroethylene, Inolub, Teflon, Fluon, Hostaflon, and Polyflon;
the antioxidants are selected from a group consisting of Irganox 1098 and Irgafos 168;
the additive and the pigment are fatty bisamide wax and zinc sulphide respectively;
said polytetrafluoroethylene is used directly during injection moulding/extrusion operations;
said mould is selected from a group consisting of plunger, retainer, and shutter mould;
said material has low cycle time of 20-25 seconds in injection moulding process ensuring high productivity; and
said composite material is made in different colours.
